(19) United States
(12) Patent Application Publication
(10) Pub. No.: US 2017/0076209 A1
(43) Pub. Date: Mar. 16, 2017

(54) Managing Performance of Systems at Industrial Sites

(71) Applicant: WellAware Holdings, Inc., San Antonio, TX (US)

(72) Inventors: David Allen Sisk, San Antonio, TX (US); Estefan Miguel Ortiz, San Anotnio, TX (US)

(21) Appl. No.: 14/853,050

(22) Filed: Sep. 14, 2015

(51) Int. Cl. G06N 5/04; G06N 99/00

(52) U.S. Cl. CPC G06N 5/04; G06N 99/005

(57) ABSTRACT

Methods, systems, and apparatus, including computer programs encoded on a computer storage medium, for receiving a first data stream from a sensor of a network of sensors monitoring well-site parameters. Obtaining a first feature vector associated with the first data stream. Determining a potential well-site event by identifying, among a stored set of well-site event models, a second feature vector from an event model that correlates with the first feature vector, where the event model includes the potential well-site event. Then, sending an alert to a user device, where the alert informs a user of the potential well-site event.

### BACKGROUND

Industrial sites, such as oil and gas well-sites, can experience operational and maintenance related events. Example operational events can include changes in well output and the filling or draining of tanks. Example maintenance related events can include degraded machinery performance and machinery failure. In some cases, personnel visit sites to adjust operational parameters or repair and maintain machinery, which can interrupt operations costing time and money. Recognizing and predicting operational and maintenance related events can help maintain optimal operation and reduce the operational downtime of a site.

### SUMMARY

In a first general aspect, innovative aspects of the subject matter described in this specification can be embodied in methods that include actions of receiving a data stream from a sensor of a network of sensors monitoring well-site parameters. Obtaining a feature vector from the data stream. Determining the feature vector correlates with a well-site event. And, storing the feature vector with data indicating the well-site event in an event model.

These and other implementations can each optionally include one or more of the following features. The method can include the actions of receiving a second data stream, and obtaining a second feature vector from the second data stream. Determining that the feature vector correlates with the well-site event can include: determining that the feature vector correlates with the second feature vector, and determining that both the feature vector and the second feature vector correlate with the well-site event. Storing the feature vector with data indicating the well-site event in the event model can include storing the correlated feature vector and second feature vector in the event model.

The event models can be stored in a database of event models. Obtaining the feature vectors can include extracting features from the data streams using an applied method of a Karhunen-Loéve theorem. Obtaining the feature vectors can include extracting features from the data streams using an applied method of a Hilbert-Huang transform. Obtaining the feature vectors can include extracting features from the data streams using at least one of Singular Spectrum Analysis, Fourier Analysis, Wavelet Decomposition, or Empirical Mode Decomposition.

Determining that feature vectors correlate with the well-site event can be performed using on a machine learning model. The data stream can include data related to at least one of an equipment parameter, an environmental parameter, a pipeline parameter, an operational parameter, or a material parameter. The method can include determining a confidence value associated with the event model.

In a second general aspect, innovative aspects of the subject matter described in this specification can be embodied in methods that include actions of receiving a first data stream from a sensor of a network of sensors monitoring well-site parameters. Obtaining a first feature vector associated with the first data stream. Determining a potential well-site event by identifying, among a stored set of well-site event models, a second feature vector from an event model that correlates with the first feature vector, where the event model includes the potential well-site event. And, sending an alert to a user device, where the alert informs a user of the potential well-site event.

These and other implementations can each optionally include one or more of the following features. The method can include the actions of obtaining a second data stream by applying an estimation model to the data stream, where the second data stream is a prediction of future data in the data stream, and obtaining a third feature vector from the second data stream. Determining the potential well-site event can include determining the potential well-site event by identifying that the second feature vector from an event model correlates with the third feature vector.

The method can include determining a confidence value associated with the generated second data stream and third feature vector. The method can include determining a confidence value of the correlation between the first feature vector and the second feature vectors is within a confidence threshold. The alert can be an e-mail, an SMS message, or a notification in a computing device application. The event model can include an action to address the potential well-site event, and the alert can include a recommendation to perform the action. The event model can include an action, and the method can include sending a signal to a control device to automatically perform the action. The steps of receiving, obtaining, identifying and sending can be performed before parameter conditions measured by the sensor change appreciably.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example system in accordance with implementations of the present disclosure.

FIG. 2 depicts an example portion of a play network.

FIG. 3 depicts a representation of an example well-site.

FIGS. 4A and 4B depict example systems for generating event models in accordance with implementations of the present disclosure.

FIG. 5 an example system for predicting site events in accordance with implementations of the present disclosure.

FIG. 6 depicts an example process for generating event models that can be executed in accordance with implementations of the present disclosure.

FIG. 7 depicts an example process for predicting site events that can be executed in accordance with implementations of the present disclosure.

Like reference symbols in the various drawings indicate like elements.

### DETAILED DESCRIPTION

Implementations of the present disclosure are generally directed to predicting site events by monitoring time dependent sensor data, and providing recommendations or performing operations that address the predicted events. More specifically, implementations of the present disclosure process time dependent sensor data received from sensor networks at multiple sites to develop event models. Data patterns in later sensor data are processed with the event models to predict site events and provide recommendations or perform actions that address the predicted events. In some examples, the data includes data associated with equipment located at the sites. In some examples, the data includes sensor data from one or more sensors located at the site. In some examples, the event models associate data patterns with known events. In some examples, the event models associate the data patterns and events with actions to improve site operations. In some examples, the event models associate the data patterns and events with corrective or maintenance actions to prevent the event (e.g., machinery failure) from occurring. Further, the sensor data can be processed to correlate patterns in the data with event models and predict a site event. In some implementations, a recommendation can be sent based on the predicted site event. In some implementations, an operating parameter of the site can be controlled based on the predicted site event.

Implementations of the present disclosure are generally applicable to sites that have operating equipment and systems. In some examples, site events can include operational events such as, for example, changes in system output (e.g., flow rates), differences in operating conditions between similar equipment (e.g., inefficient output by one piece of equipment as compared to another). In some examples, site events can include machinery maintenance or machinery failure events such as, for example, degraded machinery performance, wear of consumable parts, component failure.

Implementations of the present disclosure can analyze multivariate time-series data from multiple sensor measurements for a piece of equipment and, based the time-series data, detect degraded performance and potential machine failures to optimize preventative maintenance for the equipment. Implementations of the present disclosure can analyze multivariate time-series data from multiple sensor measurements for a piece of equipment and, based the time-series data, predict useful life or failure rate of the equipment. Implementations of the present disclosure can estimate the performance of a well or a group of wells by determining correlations among the general performance expectations for a particular formation, combination of equipment, artificial lift method, or well bore configuration, and determine which factors most influence performance of the well or a group of wells.

Implementations of the present disclosure will be discussed in further detail with reference to an example context. The example context includes oil and gas well-sites. It is appreciated, however, that implementations of the present disclosure can be realized in other appropriate contexts, for example, a chemical plant, a fertilizer plant, tank batteries (located away from a site), above-ground appurtenances (pipelines) and/or intermediate sites. An example intermediate site can include a central delivery point that can be located between a site and a refinery, for example. Within the example context, implementations of the present disclosure are discussed in further detail with reference to an example sub-context. The example sub-context includes a production well-site. It is appreciated, however, that implementations of the present disclosure can be realized in other appropriate sub-contexts, for example, an exploration well-site, a configuration well-site, an injection well-site, an observation well-site, and a drilling well-site.

In the example context and sub-context, well-sites can be located in natural resource plays. A natural resource play can be associated with oil and/or natural gas. In general, a natural resource play includes an extent of a petroleum-bearing formation, and/or activities associated with petroleum development in a region. An example geographical region can include southwestern Texas in the United States, and an example natural resource play includes the Eagle Ford Shale Play.

As used herein the term “real time” refers to transmitting or processing data without intentional delay given the processing limitations of the system, the time required to accurately measure the data, and the rate of change of the parameter being measured. For example, “real time” data streams should be capable of capturing appreciable changes in a parameter measured by a sensor, processing the data for transmission over a network, and transmitting the data to a recipient computing device through the network without intentional delay, and within sufficient time for the recipient computing device to receive (and in some cases process) the data prior to a significant change in the measured parameter. For instance, a “real-time” data stream for a slowly changing parameter (e.g., liquid level in a tank) may be one that measures, processes, and transmits parameter measurements every hour (or longer) if the parameter (e.g., tank level) only changes appreciably in an hour (or longer). However, a “real-time” data stream for a rapidly changing parameter (e.g., well head pressure) may be one that measures, processes, and transmits parameter measurements every minute (or more often) if the parameter (e.g., well head pressure) changes appreciably in a minute (or more often).

As used herein the term “data stream” refers to a series of time dependent data obtained during a time period, where each datum in the series is associated with a time value. For example, the time value can be a timestamp associated with each value, a chronological order in which each datum was measured with respect to other data, or a time difference between a measurement of one datum and that of a previous or subsequent datum. Moreover, the time value can be represented simply by the ordering of the data in a data structure. The data can be, for example, sensor data representing measurements of physical parameters over one or more time periods (e.g., seconds, minutes, hours, or days). In some examples, the data can be stochastic in nature. In some examples, the data can be measured, processed, and transmitted in real-time. In some examples, a data stream obtained during a first time period can be combined with a data stream obtained during a second time period to create a longer data stream representing data obtained during the combined first and second time periods. For example, a first data stream obtained from time T1 to time T2 can be combined with a second data stream obtained from time T2 to time T3 to create a third data stream including data obtained from time T1 to time T3.

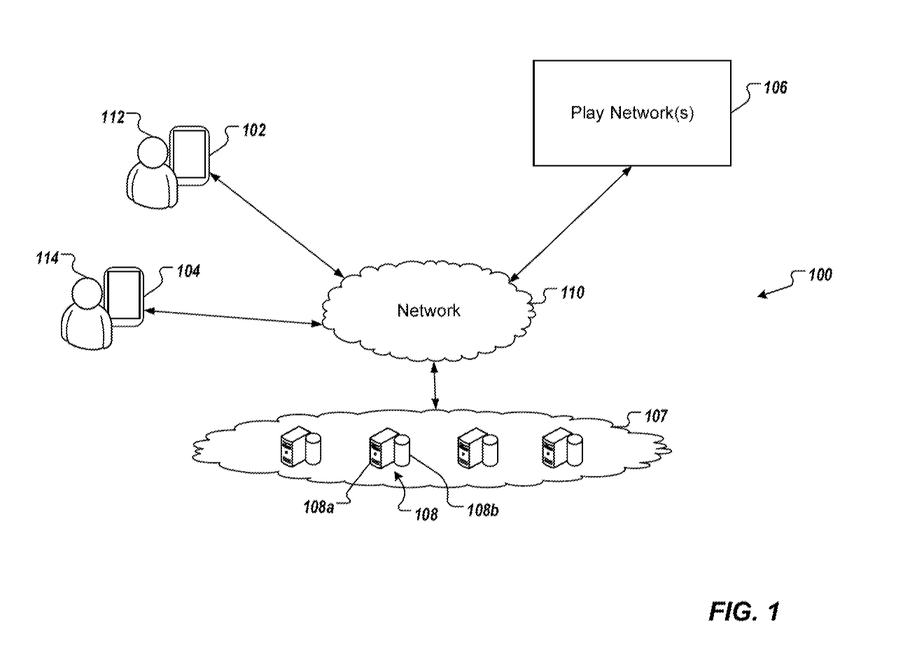

FIG. 1 depicts an example system 100 that can execute implementations of the present disclosure. The example system 100 includes one or more computing devices, such as computing devices 102, 104, one or more play networks 106, and a computing cloud 107 that includes one or more computing systems 108. The example system 100 further includes a network 110. The network 110 can include a large computer network, such as a local area network (LAN), wide area network (WAN), the Internet, a cellular network, a satellite network, a mesh network (e.g., 900 Mhz), one or more wireless access points, or a combination thereof connecting any number of mobile clients, fixed clients, and servers. In some examples, the network 110 can be referred to as an upper-level network.

The computing devices 102, 104 are associated with respective users 112, 114. In some examples, the computing devices 102, 104 can each include various forms of a processing device including, but not limited to, a desktop computer, a laptop computer, a tablet computer, a wearable computer, a handheld computer, a personal digital assistant (PDA), a cellular telephone, a network appliance, a smart phone, an enhanced general packet radio service (EGPRS) mobile phone, or an appropriate combination of any two or more of these example data processing devices or other data processing devices. The computing systems 108 can each include a computing system 108a and computer-readable memory provided as a persistent storage device 108b, and can represent various forms of server systems including, but not limited to a web server, an application server, a proxy server, a network server, or a server farm.

In some implementations, and as discussed in further detail herein, site data (e.g., oil data and/or gas data) can be communicated from one or more of the play networks 106 to the computing systems 108 over the network 110. In some examples, each play network 106 can be provided as a regional network. For example, a play network can be associated with one or more plays within a geographical region. In some examples, each play network 106 includes one or more sub-networks. As discussed in further detail herein, example sub-networks can include a low power data sub-network, e.g., a low power machine-to-machine data network (also referred to as a smart data network and/or an intelligent data network, one or more wireless sub-networks, and mesh sub-networks, e.g., 900 Mhz.

In some examples, the computing systems 108 store the well data and/or process the well data to provide auxiliary data. In some examples, the well data and/or the auxiliary data are communicated over the play network(s) 106 and the network 110 to the computing devices 102, 104 for display thereon. In some examples, user input to the computing devices 102, 104 can be communicated to the computing systems 108 over the network 110.

In general, monitoring of well-sites can include oil well monitoring and natural gas well monitoring (e.g., pressure(s), temperature(s), flow rate(s)), compressor monitoring (e.g., pressure, temperature), flow measurement (e.g., flow rate), custody transfer, tank level monitoring, hazardous gas detection, remote shut-in, water monitoring, cathodic protection sensing, asset tracking, water monitoring, access monitoring, alarm monitoring, monitoring operational parameters (e.g., operating speed), and valve monitoring. In some examples, monitoring can include monitoring the presence and concentration of fluids (e.g., gases, liquids). In some examples, monitoring can include environmental monitoring such as weather conditions, seismic measurements, well bore configuration, surface conditions, downhole conditions, presence of volatile organic compounds (VOCs). In some examples, monitoring can include equipment operational status monitoring such as method of artificial lift, age, or other properties of a well in order to model and predict the useful life/failure rate of given equipment type. In some examples, control capabilities can be provided, such as remote valve control, remote start/stop capabilities, remote access control.

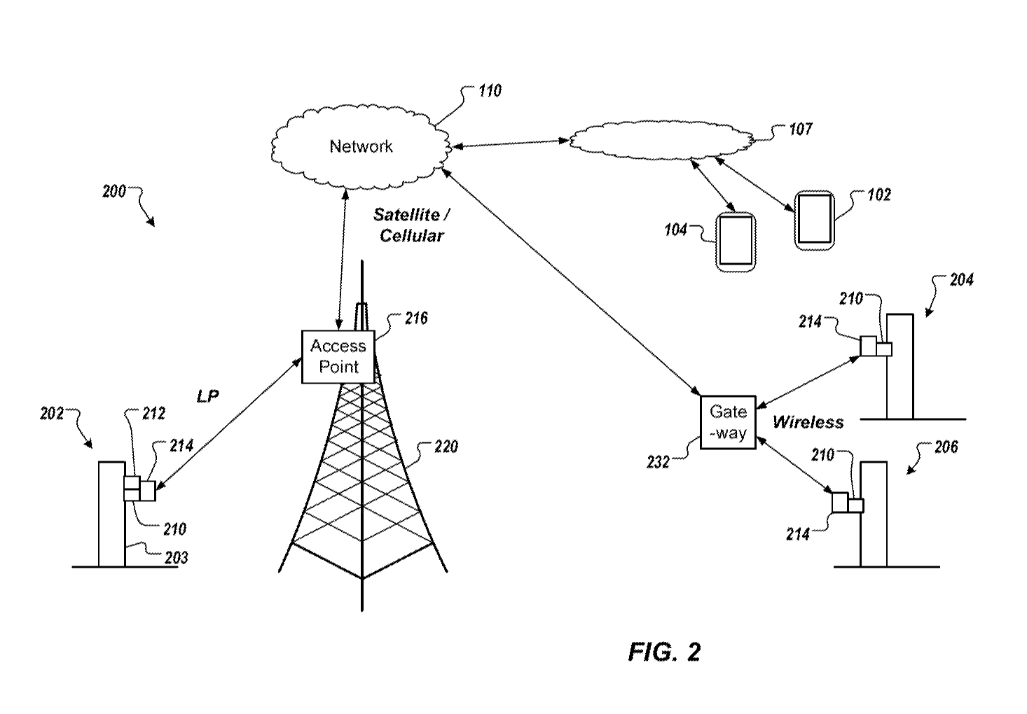

FIG. 2 depicts an example portion of an example play network 200. The example play network 200 provides low power (LP) communication, e.g., using a low power data network, and cellular and/or satellite communication for well data access and/or control. In some examples, as discussed herein, LP communication can be provided by a LP network. In the example of FIG. 2, a first well-site 202, a second well-site 204 and a third well-site 206 are depicted. Although three well-sites are depicted, it is appreciated that the example play network 200 can include any appropriate number of well-sites. In the example of FIG. 2, well monitoring and data access for the well-site 202 is provided using LP communication and cellular and/or satellite communication, and well monitoring and data access for the well-sites 204, 206 is provided using cellular, satellite, and/or mesh network communication.

The example of FIG. 2 corresponds to the example context and sub-context (a production well-site) discussed above. It is appreciated, however, that implementations of the present disclosure. In the depicted example, the well-site 202 includes a wellhead 203, a sensor system 210, and communication device 214. In some examples, the sensor system 210 includes a wireless communication device 214 that is connected to one or more sensors, the one or more sensors monitoring parameters associated with operation of the wellhead 203. In some examples, the wireless communication device 214 enables monitoring of discrete and analog signals directly from the connected sensors and/or other signaling devices. In some examples, the sensor system 210 generates data signals that are provided to the communication device 214, which can forward the data signals. In some examples, the sensor system 210 can provide control functionality (e.g., valve control). Although a single sensor system 210 is depicted, it is contemplated that a well-site can include any appropriate number of sensor systems 210 and communication devices 214. In some examples, a wireless communication device 214 is connected to one or more control devices 212. In some examples, the control device 212 can control an operation of equipment at the well-site 202 (e.g., valve operation, equipment speed control, power supply to equipment). In some examples, the wireless communication device 214 enables control of well-site equipment remotely. In some examples, the wireless communication device 214 receives data signals that are provided to the control device 212 to control equipment at the well-site 202.

Well data and/or control commands can be provided to/from the well-site 202 through an access point 216. More particularly, information can be transmitted between the access point 216, the sensor system 210, and/or the communication device 214 based on LP. In some examples, LP provides communication using a globally certified, license free spectrum (e.g., 2.4 GHz). In some examples, the access point 216 provides a radial coverage that enables the access point 216 to communicate with numerous well-sites, such as the well-site 202. In some examples, the access point 216 further communicates with the network 110 using cellular, satellite, mesh, point-to-point, point-to-multipoint radios, and/or terrestrial or wired communication.

In the depicted example, the access point 216 is mounted on a tower 220. In some examples, the tower 220 can include an existing telecommunications or other tower. In some examples, an existing tower can support multiple functionalities. In this manner, erection of a tower specific to one or more well-sites is not required. In some examples, one or more dedicated towers could be erected.

In the depicted example, the well-sites 204, 206 include respective wellheads 205, 207, and respective sensor systems 210 (discussed above). Although a single sensor system 210 is depicted for each well-site 204, 206, it is contemplated that a well-site can include any appropriate number of sensor systems 210. In some examples, well data and/or control commands can be provided to/from the well-sites 202 through a gateway 232. More particularly, information can be transmitted between the gateway 232, and the sensor systems 210 can be wireless communication (e.g., radio frequency (RF)). In some examples, the gateway 232 further communicates with the network 110 using cellular and/or satellite communication.

In accordance with implementations of the present disclosure, well-site control and/or data visualization and/or analysis functionality (e.g., hosted in the computing cloud 107 of FIGS. 1 and 2) and one or more play networks (e.g., the play networks 106, 200 of FIGS. 1 and 2) can be provided by a service provider. In some examples, the service provider provides end-to-end services for a plurality of well-sites. In some examples, the service provider owns the one or more play networks and enables well-site operators to use the play networks and control/visualization/monitoring functionality provided by the service provider. For example, a well-site operator can operate a plurality of well-sites. The well-site operator can engage the service provider for well-site control/visualization/monitoring services (e.g., subscribe for services). In some examples, the service provider and/or the well-site operator can install appropriate sensor systems, communication devices and/or gateways (e.g., as discussed above with reference to FIG. 2). In some examples, sensor systems, communication devices and/or gateways can be provided as end-points that are unique to the well-site operator.

In some implementations, the service provider can maintain one or more indices of end-points and well-site operators. In some examples, the index can map data received from one or more end-points to computing devices associated with one or more well-site operators. In some examples, well-site operators can include internal server systems and/or computing devices that can receive well data and/or auxiliary data from the service provider. In some examples, the service provider can receive messages from well-sites, the messages can include, for example, well data and an end-point identifier. In some examples, the service provider can route messages and/or auxiliary data generated by the server provider (e.g., analytical data) to the appropriate well-site operator or personnel based on the end-point identifier and the index. Similarly, the service provider can route messages (e.g., control messages) from a well-site operator to one or more appropriate well-sites.

As introduced above, implementations of the present disclosure are generally directed to predicting site events by monitoring time dependent sensor data, and providing recommendations to perform one or more operations that address the predicted event. More specifically, implementations of the present disclosure process time dependent sensor data received from sensor networks at multiple sites to develop event models. Data patterns in later sensor data are processed with the event models to predict site events and provide recommendations or perform actions that address the predicted events. In the example context and sub-context, the site includes a production well-site. As discussed in further detail herein, the data can include data associated with equipment located at the site, the data can include sensor data from one or more sensors located at the site.

In some implementations, a model can include one or more data patterns from one or more sensors that relate to a site event. In some implementations, the models include one or more actions associated with the site event that can or should be performed either to improve site operations based on the event or to prevent the event from occurring. In some examples, the data patterns are represented by signal feature vectors. In some examples, the models include confidence values associated with the model, for example, a confidence level indicating the strength of an association between data patterns in the model and an event.

In some examples, a model can be specific to a particular entity present at a well-site. Example entities can include equipment, conduits (piping) and the like. In some examples, a model can be provided for a particular well-site, the model including sensor data patterns associated with several entities present at the particular well-site and/or a site wide event (e.g., reduced output at one site compared to another site). In some examples, a model can be provided for a particular regions or group of well-sites, the model including sensor data patterns associated with entities present at the several well-sites and/or a region wide event (e.g., reduced output in one region compared to another region).

In some examples, site events can include operational events such as, for example, changes in system output (e.g., flow rates), differences in operating conditions between similar equipment (e.g., inefficient output by one piece of equipment as compared to another). In some examples, actions can include, for example, changing operating equipment parameters (e.g., regulating flow, changing pump speed, filling/emptying tanks) in order to optimize system performance (e.g., oil/gas output). In some examples, site events can include machinery maintenance or machinery failure events such as, for example, degraded machinery performance, wear of consumable parts, component failure. In some examples, actions can include, for example, performing preventative maintenance (e.g., replacing or repairing equipment) in order to prevent an event from occurring e.g., a piece of equipment from breaking or an emergency (e.g., fire or well head blow out) from occurring.

In accordance with implementations of the present disclosure, the one or more models and the sensor data are processed to predict site events and provide recommendations or perform actions based on the predicted events. Further, the data, the one or more models, and the one or more prediction rules are processed to determine an action, for example, changing operating equipment parameters (e.g., regulating flow, changing pump speed, filling/emptying tanks) or performing preventative maintenance (e.g., replacing or repairing equipment). In some implementations, one or more graphical user interfaces (GUIs) can be presented on computing devices, which provide a notification of the recommended action and depict representations of the sensor data (e.g., graphs) related to the event.

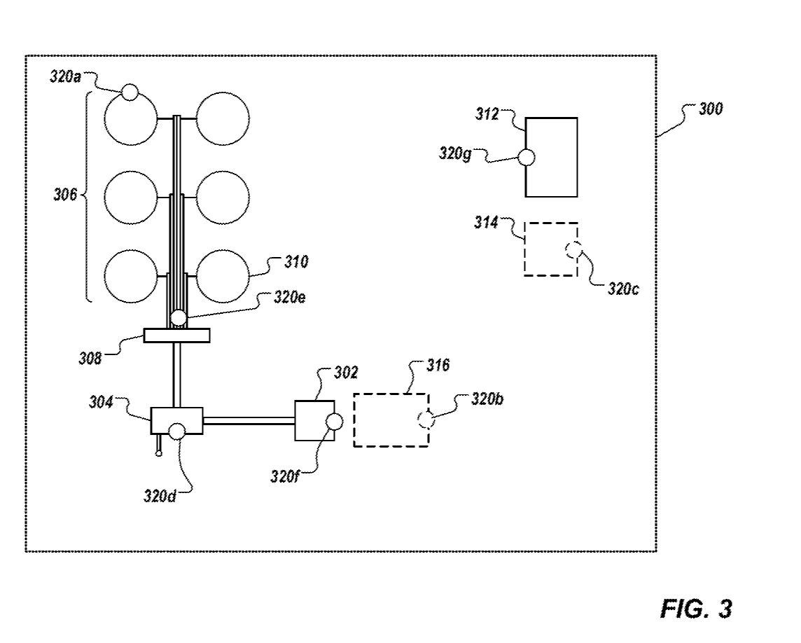

FIG. 3 depicts a representation of an example well-site 300. The example well-site 300 can include a production well-site, in accordance with the example sub-context provided above. In the depicted example, the well-site 300 includes a well-head 302, an oil and gas separator 304 and a storage tank system 306. In the depicted example, the storage tank system 306 includes a manifold 308 and a plurality of storage tanks 310. The example well-site 300 further includes a base station 312. In some examples, the well-site 300 can include a local weather station 314. In some examples, the well-site 300 can include artificial lift equipment 316, e.g., to assist in extraction of oil and/or gas from the well.

In some examples, the well-site 300 includes one or more sensors 320a-320g. In some examples, each sensor 320a-320g can be provided as a single sensor. In some examples, each sensor 320a-320g can be provided as a cluster of sensors, e.g., a plurality of sensors. Example sensors can include fluid sensors, e.g., gas sensors, temperature sensors, and/or pressure sensors. Each sensor 320a-320g is responsive to a condition, and can generate a respective signal based thereon. In some examples, the signals can be communicated through a network, as discussed above with reference to FIG. 2.

Referring again to FIG. 3, sensors 320a-320g can include temperature sensors and/or pressure sensors. For example, the sensors 320a-320g can be responsive to the temperature and/or pressure of a fluid. That is, the sensors 320a-320g can generate respective signals that indicate the temperature and/or pressure of a fluid.

As discussed herein, data from the sensors 320a-320g can be provided to a back-end system for processing. For example, data can be provided through a play network, e.g., the play network(s) 106 of FIG. 1, to a computing cloud, e.g., the computing cloud 107. The computing cloud 107 can process the sensor data to develop event models. Further, the computing cloud 107 can process the sensor data and the models to predict events and provide output to one or more computing devices (e.g., the computing devices 102, 104 of FIG. 1). For example, and as discussed in further detail herein, the computing cloud can process the sensor data to develop event models.

In some implementations, the computing cloud 107 can process the sensor data to correlate the sensor data with one or more event models (e.g., using a computer learning model) and predict a site event. In some examples, in response to predicting a site event, the computing cloud 107 can the send a recommended action, based on the predicted event, to one or more computing devices (e.g., the computing devices 102, 104 of FIG. 1). In some examples, the recommendation includes charts or graphs of the sensor data related based on which the event was predicted. In some examples, the recommendation includes a link to the charts or graphs. In some examples, in response to predicting a site event, the computing cloud 107 can the send a instructions to a controlling device at the site (e.g., a valve controller) to perform an action (e.g., close or open a valve) based on the predicted event.

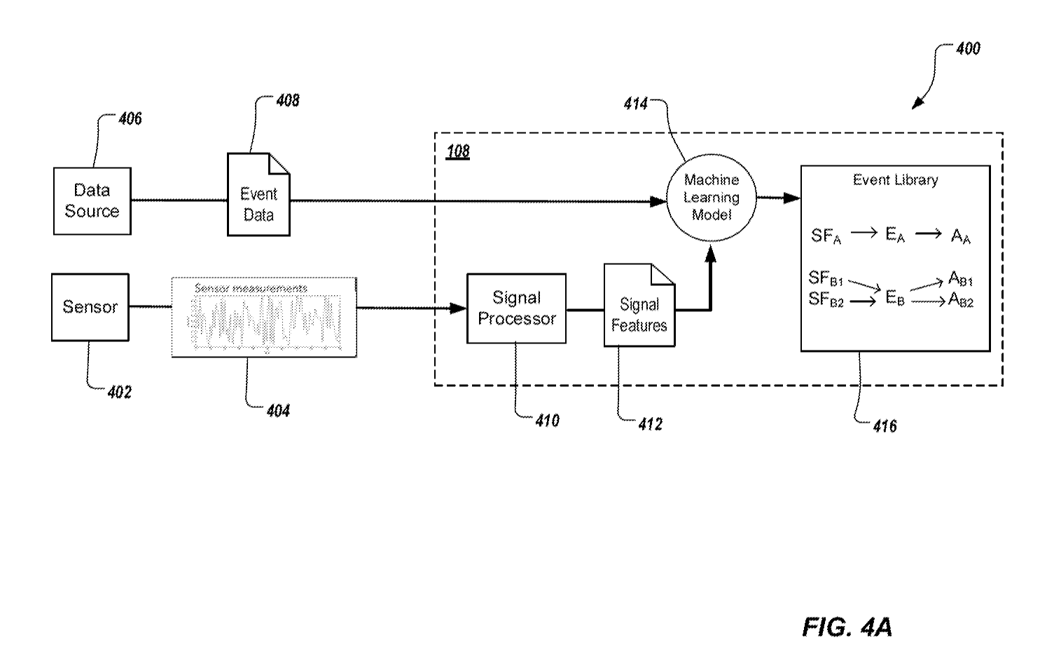

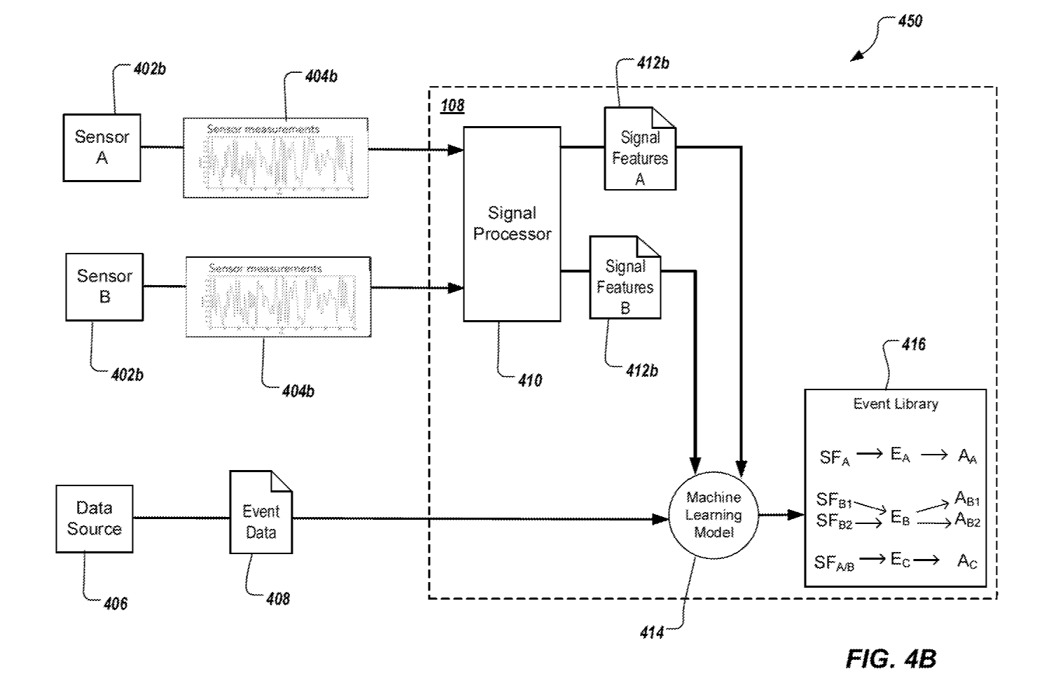

FIG. 4A depicts an example system 400 for generating event models in accordance with implementations of the present disclosure. The system 400 includes one or more computing systems 108 (e.g., computing cloud 107 computing systems). The computing systems 108 include at least one signal processor 410 and at least one computer learning model 414 to generate event models 416. The signal processor 410 can be, for example, implemented in hardware (e.g., a signal processing chip or circuit), or in software (e.g., as computer code executed by a non-specific processor). The machine learning model 414 can be implemented using one or more machine learning methods such as, for example, Support Vector Machines, Neural Networks, Deep Learning, Bayesian Inference, Unsupervised Methods of Clustering and Learning.

As discussed above, event models 416 associate data patterns, such as signal features 412 (e.g., SF_{A}, SF_{B1}, and SF_{B2}), with site events (e.g., E_{A} and E_{B}). In some examples, the event models associate signal features 412 (e.g., SF_{A}, SF_{B1}, and SF_{B2}) and events (e.g., E_{A} and E_{B}) with actions (e.g., A_{A}, A_{B1}, and A_{B2}) to improve site operations or otherwise address the associated event. In some examples, site events can include operational events such as, for example, changes in system output (e.g., flow rates), different in operating conditions between similar equipment (e.g., inefficient output by one piece of equipment as compared to another). In some examples, site events can include machinery maintenance or machinery failure events such as, for example, degraded machinery performance, wear of consumable parts, or component failure. Accordingly, in some examples, actions can include alerts about the event, recommendations to perform corrective or maintenance actions to prevent the event (e.g., machinery failure) from occurring, recommendations to adjust site operating parameters to optimize site operations based on the event, or control signals to control site operations (e.g., a control signal to a control device 212 of FIG. 2).

In some examples, an event model 416 can associate more than one set of signal features (e.g., SF_{B1}, and SF_{B2}) with a particular site event (e.g., E_{B}). For example, a particular event (e.g. the breakdown of a machine) may be indicated by multiple unrelated data trends (e.g., lowing oil pressure or rising bearing temperature). Therefore, multiple signal feature sets (e.g., SF_{B1}, and SF_{B2}) can be associated with the same site event (e.g., E_{B}) in some event models 416. In addition, although resulting in the same event, addressing the cause of the different data trends represented by signal feature sets (e.g., SF_{B1}, and SF_{B2}) may require performing different actions (e.g., repairing an oil leak or replacing a worn bearing). Therefore, the same event can also be associated with multiple actions (e.g., A_{B1}, and A_{B2}) in the event model 416, where the appropriate action is related to the signal feature set that triggered the site event (e.g., repairing a leak for lowering oil pressure and replacing a worn bearing for rising bearing temperature). In some examples, however, as discussed in more detail below in reference to FIG. 4B, a particular site event may be indicated by multiple interrelated data trends.

In an example operation of system 400, a computing system 108 receives a data stream 404 from a sensor 402 (e.g., a sensor in sensor network 210 of FIG. 2 such as one of sensors 320a-320g of FIG. 3), and event data 408 from a data source 406. The data source 406 can be a computing device (e.g., computing devices 102, 104 of FIG. 1), a database of site event logs, or a prior generated event model 416. Event data 408 can include, but is not limited to, communications from computing devices 104, 104 related to site events, electronic site and/or equipment logs, event and signal data included in one or more event models 416. In some implementations, the data sources 406 can include, for example, digitized manual logs or records, oil and gas data from third party sources (e.g., government computing systems such as the Texas Railroad Commission), weather data, and seismic data. The data stream 404 is processed by the signal processor 410 to extract signal features from the data stream, for example, signal features 412. In some examples, the signal processor performs time series analysis operations to extract the signal features 412 from the data stream 404. In some examples, the time series analysis operations can include, but are not limited to, applied methods of the Karhunen-Loéve theorem, and the Hilbert-Huang transform, including, but not limited to, Singular Spectrum Analysis, Fourier Analysis, Wavelet Decomposition, or Empirical Mode Decomposition. In some examples, the signal features 412 are represented by a feature vector that represents data trends over time.

The machine learning model 414 processes the signal features 412 and the event data 408 to correlate signal features 412 with related events, and thereby, generate new event models 416 or refine existing event models 416. In some examples, the event models 416 are stored in a database or library of event models and used, along with other data streams, to predict site events, and provide alerts, recommendations, or control equipment based on the predicted site events, as discussed in more detail below. In some examples, the machine learning model 414 also generates confidence values associated with respective event models 416. An event model confidence value represents a level of confidence that the signal features of a particular event model are accurately associated with a particular site event in the event model.

In some examples, the event data 408 can include data indicating that a particular action was performed (e.g., by an operator) to address the event (e.g., correct a malfunction or adjust an operational parameter). In such examples, the machine learning model 414 can also associate the action with the event, and, in some examples, with the signal features 412 that correlated with the event in the generated event model 416.

FIG. 4B depicts an example system 450 for generating event models in accordance with implementations of the present disclosure. System 450 is similar to system 400, but is modified process multiple data streams 404a, 404b. Like system 400, system 450 receives sensor data (e.g., data streams 404a, 404b) and event data 408, processes the data streams using a signal processor 410, and generates event models 416 based on the sensor data (e.g., data streams 404a, 404b) and event data 408. However, as introduced above, system 450 processes multiple data streams 404a, 404b to determine whether the data streams 404a, 404b, are correlated and relate to a common site event. Although, FIG. 4B depicts two data streams, it is appreciated that the example play system 450 can include and correlate any appropriate number of data streams.

In an example operation of system 450, the computing system 108 receives data streams 404a, 404b from sensors 402a, 402b (e.g., sensors in sensor network 210 of FIG. 2 such as sensors 320a-320g of FIG. 3), and event data 408 from a data source 406. The data streams 404a, 404b are processed, as described above, by the signal processor 410 to extract signal features 412a from the data stream 404a and signal features 412b from data stream 404b. In some examples, the signal features 412a, 412b are represented by feature vectors that representing data trends in the data streams 404a, 404b. Signal features 412a and 412b are processed by machine learning model 414 to determine whether the data streams 404a, 404b are correlated.

The machine learning model 414 processes signal features 412a and 412b and the event data 408 to correlate signal features 412 both with each other (e.g., SF_{A/B}) and with related events (e.g., E_{C}), and thereby, generate new event models 416 or refine existing event models 416. As noted above In some examples, the event models 416 are stored in a database or library of event models and used, along with other data streams, to predict site events, and provide alerts, recommendations, or control equipment based on the predicted site events, as discussed in more detail below. In some examples, the machine learning model 414 also generates confidence values associated with respective event models 416. An event model confidence value represents a level of confidence that the signal features of a particular event model are accurately associated with a particular site event in the event model.

As described above, in some examples, the event data 408 can include data indicating that a particular action was performed (e.g., by an operator) to address the event (e.g., correct a malfunction or adjust an operational parameter). In such examples, the machine learning model 414 can also associate the action with the event, and, in some examples, with the signal features 412 that correlated with the event in the generated event model 416.

In a first example, a combination of decreasing oil pressure and decreasing output oil flow can indicate that the potential breakdown of a pump due to a casing leak. The signal features corresponding to the correlated decreasing oil pressure and decreasing output oil flow can be stored as an event model for pump failure due to a casing leak, along with the corrective actions of repairing the casing. In a second more complex example, oil production output data from multiple wells at a first site (e.g., a site with low production output) may be correlated with operational parameter data of the wells and environmental data of the site. The correlated data from the first well site may be compared to similarly correlated data from a second site (e.g., a site with high production output). From the combined data of both sites the machine learning model 414 can determine that the first site is being operated inefficiently (e.g., a site event associated with the first site) and determine actions to improve the operation of the first site. The correlated production output data and operational parameters of the wells at the first site and the environmental conditions at the first site can be stored as an event model for inefficient site operations of sites in similar environmental conditions. In some examples, the action can be determined based on the operation data from the second site, for example, the action may be adjusting operational parameters to be similar to those of the second site while accounting for environmental differences between the two sites. These actions can also be stored with the event model for inefficient site operations of sites in similar environmental conditions.

In some examples, the data streams 404, 404a, 404b can include data obtained during time periods of varying lengths. For example, some data trends related to some site events (e.g., changes in oil production relative to other sites) may occur over relatively long periods of time (e.g., hours, days, weeks, etc.), whereas data trends related to other site events may occur relative short periods of time (e.g., minutes, seconds, or fractions of a second). In the example of data trends occurring over longer periods of time (e.g., a gradual slowing of production indicated by a gradually lowering oil output), the related data may be received at intervals shorter than the trend indicating the event (e.g., hourly oil output data). In such examples, the computing system 108 can store and combine shorter data streams (e.g., hourly data streams) into longer data streams (e.g., week long data streams), such that the signal processing and machine learning analysis (e.g., event correlation) can be performed on the data stream representing data trends over a longer time period.

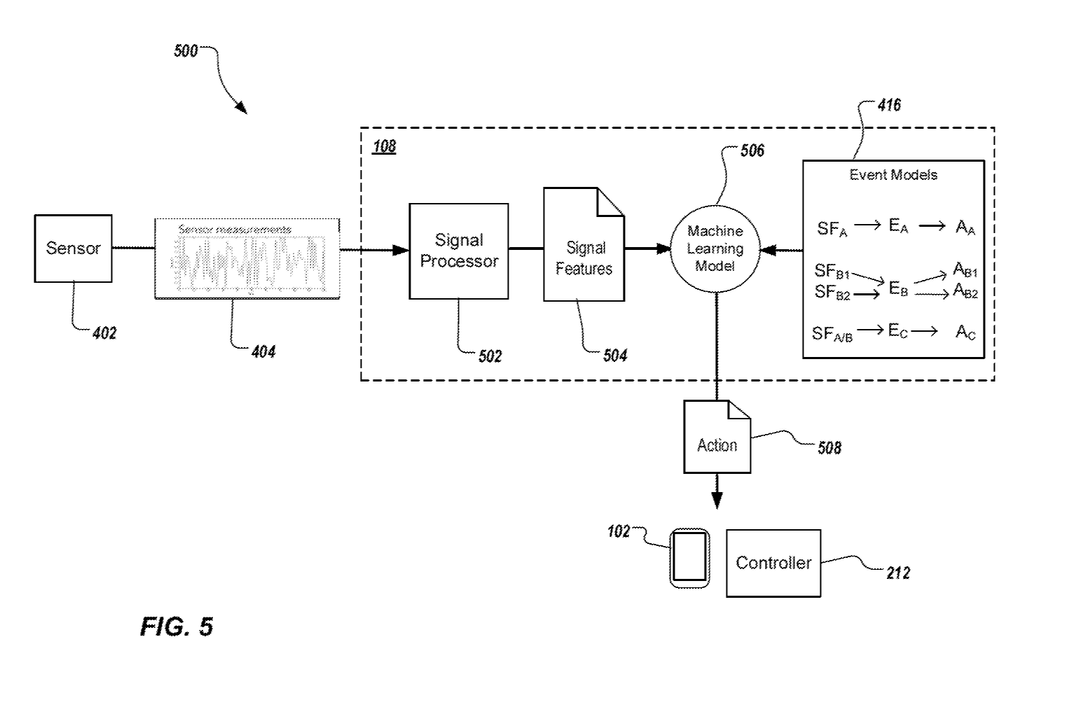

FIG. 5 an example system 500 for predicting site events in accordance with implementations of the present disclosure. Similar to systems 400 and 450, the system 500 includes one or more computing systems 108 (e.g., computing cloud 107 computing devices). The computing systems 108 include at least one signal processor 502 and at least one computer learning model 506 predict site events using event models 416. The signal processor 502 can be, for example, implemented in hardware (e.g., a signal processing chip or circuit), or in software (e.g., as computer code executed by a non-specific processor). As in systems 400 and 450, the machine learning model 506 can be implemented using one or more machine learning methods such as, for example, Support Vector Machines, Neural Networks, Deep Learning, Bayesian Inference, Unsupervised Methods of Clustering and Learning. In some examples, the machine learning model 506 implements the same machine learning method or combination of machine learning methods as machine learning model 414 from systems 400 and 450. In some examples, the machine learning model 506 implement the a different machine learning method or combination of machine learning methods as machine learning model 414 from systems 400 and 450.

In an example operation of system 500, a computing system 108 receives a data stream 404 from a sensor 402 (e.g., a sensor in sensor network 210 of FIG. 2 such as one of sensors 320a-320g of FIG. 3. The signal processor 502 processes the received data stream 404 to extract signal features from the data stream 404. In some examples, the signal processor performs time series analysis operations to extract the signal features 504 from the data stream. In some examples, the time series analysis operations can include, but are not limited to, applied methods of the Karhunen-Loéve theorem, and the Hilbert-Huang transform, including, but not limited to, Singular Spectrum Analysis, Fourier Analysis, Wavelet Decomposition, or Empirical Mode Decomposition. In some examples, the signal processor 502 uses predictive time series models (e.g., linear and/or non-linear auto regressive models) to predict future data stream data from an input data stream 404. In such examples, the signal processor 502 extracts signal features 504 from the predicted data stream.

The machine learning model 506 analyzes the signal features 504 from either the received data stream or a predicted data stream to determine whether the signal features 504 correlate with a site event represented by one of the event models 416. If the machine learning model 506 determines that the signal features 504 correlate with an event model with a confidence value that is within a correlation confidence threshold, the machine learning model 506 causes the computing system 108 to perform actions 508 associated with the correlated event model 416. The actions can be actions to inform site operators of a site event represented by the event model 416, to address the site event represented by the event model 416, or both. For example, the machine learning model 506 may determine that signal features 504 correlate to signal features SF_{B1} of the event model for site event E_{B} with a correlation confidence value of 85%, which exceeds the correlation confidence threshold of 80%. In response, the machine learning model instructs the computing system 108 to perform the actions (e.g., action A_{B1}) associated with the event model and the correlated signal features.

In some examples, actions 508 can include, but are not limited to, sending an alert to one or more computing devices (e.g., computing devices 102, 104) notifying a site operator the site event or sending signals to a control device 510 to automatically operate site equipment to prevent or address the site event. In some examples, an alert can include a recommended action or course of actions to prevent or address the site event. In some examples, an alert can be sent as an e-mail, SMS message, or notification in a computing device application (e.g., a well-site monitoring application). In some examples, an alert can include graphs or links to graphs of the data stream associated with the site event. In some examples, an alert can include a recommended action and an input that causes a signal to be sent (e.g., by the computing cloud 107 or from the user's computing device 102, 104) to a control device 510 to operate site equipment.

In some implementations, as in system 450, multiple data streams 404 can be received and processed by the signal processor 502 to extract signal features 504 from each of the received data streams 404. In some examples, the signal processor 502 can estimate future data streams for all or a subset of the multiple data streams 404 and extract signal features 504 from the predicted data streams. As in system 450, the machine learning model 506 can process the signal features to determine whether any of the multiple sets of signal features from the multiple data streams correlate with each other (e.g., the rising oil pressure and machine temperature discussed above). The machine learning model 506 analyzes the correlated sets of signal features to determine whether the sets of signal features further correlate with a site event represented by one of the event models 416. If the machine learning model 506 determines that the sets of signal features correlate with an event model 416 with a confidence value that is within a correlation confidence threshold, the machine learning model 506 causes the computing system 108 to perform actions 508 associated with the correlated event model 416.

Continuing the first example from above, after the event model for pump failure due to a casing leak has been generated, a second pump (or even the same pump) may have the same problem. The data streams for oil pressure and output oil flow for the second pump are transmitted to the computing cloud 107 and one of the computing systems 108 processes the data streams. The sets of signal features for the oil pressure and output flow may indicate that both values are decreasing and are correlated, both with each other and with the event model for pump failure due to a casing leak. In response to determining that sets of signal features correlate the event model, the computing system 108 can send an appropriate alert to one or more well-site operators informing them of the pending pump failure do to a casing leak. In some implementations, the alert may include an option of remotely shutting down the pump (e.g., by a control device 510). For example, an operator may wish to shut down the pump remotely if the operator is at different well-site and cannot attend to the casing leak expeditiously to prevent further damage or loss of oil.

In some examples, the correlation confidence threshold can be tiered and the actions determined based on which tier of the correlation confidence threshold a given correlation value falls within. For example, a correlation confidence threshold may include a first tier (e.g. 90-100% correlation) in which the computing system performs a first action (e.g., automatically controlling well-site equipment), a second tier (e.g. 80-90% correlation) in which the computing system performs a second action (e.g., sending an alert and recommended action to a well-site operator's computing device 102, 104), and a second tier (e.g. 60-80% correlation) in which the computing system performs a third action (e.g., sending an alert simply informing an operator of the possibility that the well-site event may occur and suggesting further investigation).

In some examples, the correlation confidence value can be combined with an event model confidence value to form a combined confidence value. In such examples, the combined confidence value can be compared with the correlation confidence threshold to determine whether to perform the action associated with an event model. A combined confidence value can represent the overall confidence that a received data stream is predictive of a particular site event. For example, a received data stream may correlate strongly with signal features of an event model, but the event model confidence value may be low (e.g., the correlation strength between the signal features of the event model and the particular event represented by the model). Therefore, the overall confidence that the received data stream is predictive of that particular event would be low.

In some examples, the signal features 504 may correlate with more than one event models, with correlation confidence values that are within a correlation confidence threshold. In such examples, the machine learning model 506 can cause the computing system 108 to perform actions associated with all or a subset of the correlated event models. In some examples, the machine learning model 506 can cause the computing system 108 to perform actions associated with only the event model having the greatest correlation confidence with the signal features 504.

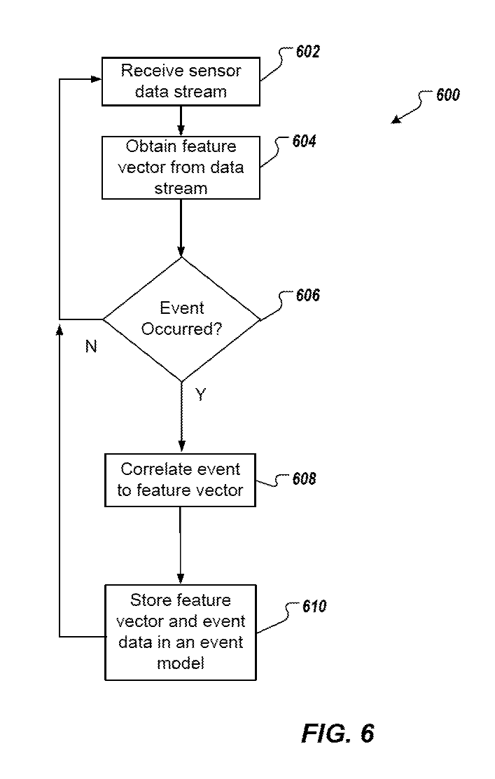

FIG. 6 depicts an example process 600 for generating event models that can be executed in accordance with implementations of the present disclosure. In some examples, the example process 600 can be provided as one or more computer-executable programs executed using one or more computing devices. In some examples, the process 600 is executed to generating event models for well-sites.

A sensor data streams is received (602). For example, computing cloud 107 of FIG. 1 can receive a sensor data stream from a sensor of a network of sensors monitoring well-site parameters. A feature vector is obtained from the data stream (604). For example, the computing cloud 107 extracts a feature vector from the data stream. If a site event occurs (606), the computing cloud 107 determines whether the feature vector correlates with a well-site event (608). In some examples, the computing cloud 107 can receive event data and correlate the feature vector with the received event data. When the feature vector correlates with a well-site event, the feature vector is stored in an event model related to the well-site event (610). In some examples, event data such as actions to prevent or address the event are stored in the event model. In some examples, event model is stored in a database of event models.

In some examples, a feature vector can be obtained by extracting features from the data streams using time series analysis operations such as applied methods of the Karhunen-Loéve theorem, and the Hilbert-Huang transform, including, but not limited to, Singular Spectrum Analysis, Fourier Analysis, Wavelet Decomposition, or, Empirical Mode Decomposition. In some examples, a machine learning model can be used to determine that a feature vector correlate with a well-site event.

In some examples, feature vectors from two or more data streams can be correlated with each other, and the correlated feature vectors can be associated with (e.g., correlated to) a well-site event. In some examples, a confidence value can be determined for the correlation between a feature vector and a well-site event, and the confidence value can be included with the event model.

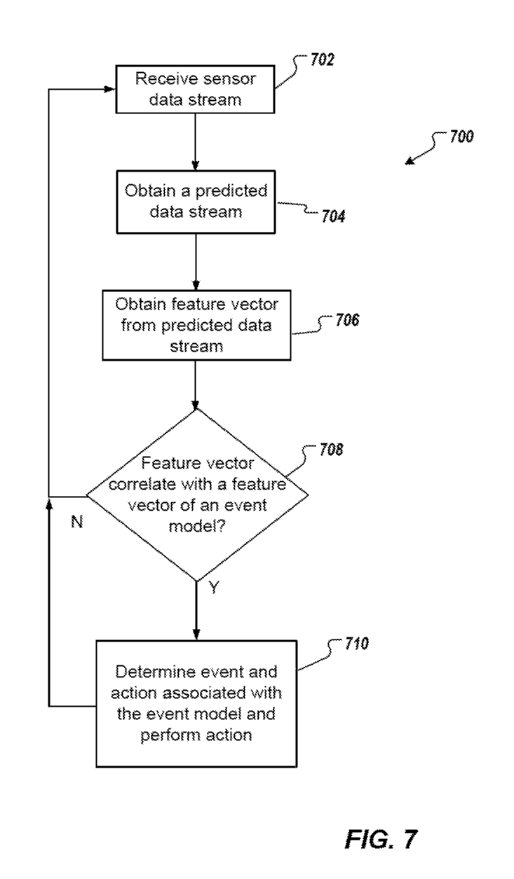

FIG. 7 depicts an example process 700 for predicting site events that can be executed in accordance with implementations of the present disclosure. In some examples, the example process 700 can be provided as one or more computer-executable programs executed using one or more computing devices. In some examples, the process 700 is executed to predict well-site events.

A sensor data streams is received (702). For example, computing cloud 107 of FIG. 1 can receive a sensor data stream from a sensor of a network of sensors monitoring well-site parameters. A predicted data stream is obtained from the received data stream (704). For example, the computing cloud 107 can estimate a predicted data stream using predictive time series models (e.g., linear and/or non-linear auto regressive models). A feature vector is obtained from the data stream (706). For example, the computing cloud 107 extracts a feature vector from the predicted data stream. The computing cloud 107 determines whether the feature vector correlates with a feature vector in an event model (708). If the feature vector correlates with a well-site event, the feature vector is stored in an event model related to the well-site event, the computing cloud 107 determines the site event represented by the model and an action associated with the model, and performs the action (710). For example, the computing cloud 107 can send an alert to a well-site operator that includes a recommended action or course of action to prevent or address the site event. For example, the alert can be an e-mail, an SMS message, or a notification in a computing device application. In some examples, process 700 is performed in “real time” such that data streams are received and processed, and the alert is sent before the measured site conditions represented by the data streams change appreciably.

In some examples, an estimation confidence value indicating the accuracy of the predicted data stream may be determined. In some examples, a correlation confidence value indicating the strength of correlation between the feature vector from the data stream and the feature vector from the event model can be determined. In some examples, the estimation confidence value is considered when determining the correlation confidence value to ensure that any potential inaccuracies in the predicted data stream are also reflected by the correlation confidence value. In some examples, the correlation confidence value is compared to a confidence threshold, and the action is performed only if the correlation confidence value is within the confidence threshold.

Implementations of the subject matter and the operations described in this specification can be realized in digital electronic circuitry, or in computer software, firmware, or hardware, including the structures disclosed in this specification and their structural equivalents, or in any appropriate combinations thereof. Implementations of the subject matter described in this specification can be realized using one or more computer programs, i.e., one or more modules of computer program instructions, encoded on computer storage medium for execution by, or to control the operation of, data processing apparatus, e.g., one or more processors. In some examples, program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. In some examples, the data processing apparatus can include special purpose logic circuitry, e.g., an FPGA (field programmable gate array) or an ASIC (application specific integrated circuit). In some examples, the data processing apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer can include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a mesh network, a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any implementation of the present disclosure or of what may be claimed, but rather as descriptions of features specific to example implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method executed by one or more processors, the method comprising:
receiving, by the one or more processors, a data stream from a sensor of a network of sensors monitoring well-site parameters;
obtaining, by the one or more processors, a feature vector from the data stream;
determining, by the one or more processors, the feature vector correlates with a well-site event; and
storing, by the one or more processors, the feature vector with data indicating the well-site event in an event model.

2. The method of claim 1, further comprising:
receiving a second data stream; and
obtaining a second feature vector from the second data stream,
wherein determining that the feature vector correlates with the well-site event comprises:
determining that the feature vector correlates with the second feature vector, and
determining that both the feature vector and the second feature vector correlate with the well-site event, and
wherein storing the feature vector with data indicating the well-site event in the event model comprises storing the correlated feature vector and second feature vector in the event model.

3. The method of claim 1, wherein the event models is stored in a database of event models.

4. The method of claim 1, wherein obtaining the feature vectors includes extracting features from the data streams using an applied method of a Karhunen-Loéve theorem.

5. The method of claim 1, wherein obtaining the feature vectors includes extracting features from the data streams using an applied method of a Hilbert-Huang transform.

6. The method of claim 1, wherein obtaining the feature vectors includes extracting features from the data streams using at least one of Singular Spectrum Analysis, Fourier Analysis, Wavelet Decomposition, or Empirical Mode Decomposition.

7. The method of claim 1, wherein determining that feature vectors correlate with the well-site event is performed using a machine learning model.

8. The method of claim 1, wherein the data stream includes data related to at least one of an equipment parameter, an environmental parameter, a pipeline parameter, an operational parameter, or a material parameter.

9. The method of claim 1, further comprising determining a confidence value associated with the event model.

10. A computer-implemented method executed by one or more processors, the method comprising:
receiving, by the one or more processors, a first data stream from a sensor of a network of sensors monitoring well-site parameters;
obtaining, by the one or more processors, a first feature vector associated with the first data stream;
determining a potential well-site event by identifying, by the one or more processors from a stored set of well-site event models, a second feature vector from an event model that correlates with the first feature vector, the event model including the potential well-site event; and
sending an alert to a user device, the alert informing a user of the potential well-site event.

11. The method of claim 10, further comprising:
obtaining a second data stream by applying an estimation model to the data stream, the second data stream being a prediction of future data in the data stream; and
obtaining a third feature vector from the second data stream, and
wherein determining the potential well-site event comprises determining the potential well-site event by identifying that the second feature vector from an event model correlates with the third feature vector.

12. The method of claim 10, further comprising determining a confidence value associated with the generated second data stream and third feature vector.

13. The method of claim 10, further comprising determining a confidence value of the correlation between the first feature vector and the second feature vectors is within a confidence threshold.

14. The method of claim 10, wherein the alert is an e-mail, an SMS message, or a notification in a computing device application.

15. The method of claim 10, wherein the event model includes an action to address the potential well-site event, and
wherein the alert includes a recommendation to perform the action.

16. The method of claim 10, wherein the event model includes an action, and
wherein the method further comprises sending a signal to a control device to automatically perform the action.

17. The method of claim 10, wherein the steps of receiving, obtaining, identifying and sending are performed before parameter conditions measured by the sensor change appreciably.

18. A system comprising:
one or more processors; and a data store coupled to the one or more processors having instructions stored thereon which, when executed by the one or more processors, causes the one or more processors to perform operations comprising:
receiving, by the one or more processors, a first data stream from a sensor of a network of sensors monitoring well-site parameters;
obtaining, by the one or more processors, a first feature vector associated with the first data stream;
determining a potential well-site event by identifying, by the one or more processors among a stored set of well-site event models, a second feature vector from an event model that correlates with the first feature vector, the event model including the potential well-site event; and
sending an alert to a user device, the alert informing a user of the potential well-site event.

19. The system of claim 18, wherein the operations further comprise:
obtaining a second data stream by applying an estimation model to the data stream, the second data stream being a prediction of future data in the data stream; and
obtaining a third feature vector from the second data stream, and
wherein determining the potential well-site event comprises determining the potential well-site event by identifying, from the stored set of well-site event models, that the second feature vector from an event model that correlates with the third feature vector.

20. The system of claim 18, wherein the event model includes an action, and
wherein the operations further comprise sending a signal to a control device to automatically perform the action.
